(19) United States
(12) Patent Application Publication
(10) Pub. No.: US 2014/0152847 A1
(43) Pub. Date: Jun. 5, 2014

(54) PRODUCT COMPARISONS FROM IN-STORE IMAGE AND VIDEO CAPTURES

(71) Applicant: GOOGLE INC., Mountain View, CA (US)

(72) Inventors: Asaf Zomet, Jerusalem (IL); Michael Shynar, Tel Aviv (IL); Dvir Keysar, Herzliya (IL); Gal Chechik, Los Altos, CA (US)

(73) Assignee: GOOGLE INC., Mountain View, CA (US)

(21) Appl. No.: 13/692,994

(22) Filed: Dec. 3, 2012

(51) Int. Cl. G06Q 30/06; H04N 5/232

(52) U.S. Cl. CPC G06Q 30/0629; H04N 5/23293
USPC 348/207.1; 382/218; 348/222.1

(57) ABSTRACT

Systems and methods are described herein for comparing products in a marketplace. An image or video of the products may be captured using a camera associated with a mobile device. User input may be received to select two or more products within the image. Machine vision techniques may be applied to specifically identify the selected products. Product features associated with each of the identified products may be retrieved and formatted into a comparison of product features. The comparison may be presented to the user.

### TECHNICAL FIELD

The present disclosure relates to systems and methods for enabling mobile device users to compare products. A user may capture images or videos of products to compare using a camera associated with a mobile device.

### BACKGROUND

A customer shopping in a store may be presented with a potentially overwhelming array of choices. The customer may desire to research the choices to compare various products and to guide their selection. Traditional technology required researching or looking up each item separately. Even with the assistance of mobile devices, manually entering the specific name, model number, or other relevant identifier for each item to be compared is prohibitively cumbersome, time consuming, and error prone.

In addition to challenges in rapidly obtaining detailed information on various products to be compared, meaningfully comparing products requires knowledge of important differentiating features. Understanding these differentiating features allows a user to determine which features are worth comparing between the various products. Without significant knowledge of the type of products being compared, a user lacks the background to identify these differentiating features and thus meaningfully compare two or more products against one another.

### SUMMARY

In certain example embodiments described herein, methods and systems can compare products in a marketplace. An image or video of the products may be captured using a camera associated with a mobile device. User input may be received to select two or more products within the image or video. Machine vision techniques may be applied to specifically identify the selected products. Product features associated with each of the identified products may be retrieved and formatted into a comparison of product features. The comparison may be presented to the user.

These and other aspects, objects, features, and advantages of the exemplary embodiments will become apparent to those having ordinary skill in the art upon consideration of the following detailed description of illustrated exemplary embodiments, which include the best mode of carrying out the invention as presently perceived.

### BRIEF DESCRIPTION OF THE DRAWINGS

FIG. 1 is a block diagram depicting a system for comparing products within an image or video in accordance with one or more embodiments presented herein.

FIG. 2 is a block diagram depicting a system for capturing an image of products in a marketplace and selecting products from within the image in accordance with one or more embodiments presented herein.

FIG. 3 is a block flow diagram depicting a method for comparing products within an image or video in accordance with one or more embodiments presented herein.

FIG. 4 is a block flow diagram depicting a method for identifying products within an image or video in accordance with one or more embodiments presented herein.

FIG. 5 is a block flow diagram depicting a method for comparing product features in accordance with one or more embodiments presented herein.

FIG. 6 is a block diagram depicting a computing machine and a module in accordance with one or more embodiments presented herein.

### DETAILED DESCRIPTION OF EXEMPLARY EMBODIMENTS

### Overview

Embodiments described herein enable comparing features of products in response to a user of a mobile device capturing an image or video of the products in a marketplace. The user may capture an image or a video of products in a marketplace, such as a store, using a camera associated with the mobile device. Products may be automatically identified within the image or video. The user may select two or more of the identified products for comparison. Alternatively, the user may specify portions of the image or video to be examined prior to the automatic identification of products.

Automatic identification of the products may include machine vision processing to extract visual identifiers within the image or video. The visual identifiers may include machine vision features, text, barcodes, or other coded information for identifying the product. The extracted features, text, barcodes, or other coded information may be leveraged to identify products from a database of product identifiers. Identification of the products may be assisted by first identifying a product category for the products being compared.

Products identified and selected within the image or video may be compared for the user. This comparison may include displaying one or more tables to the user where the tables compare features of the products. The features for comparing products may vary based on the type or category of product being compared. The featured may be manually specified or automatically determined as those features significant to comparing a given category of products.

Aspects of embodiments will be explained in more detail in the following description, read in conjunction with the figures illustrating the program flow.

### Example System Architecture

Turning now to the drawings, in which like numerals indicate like (but not necessarily identical) elements throughout the figures, example embodiments are described in detail.

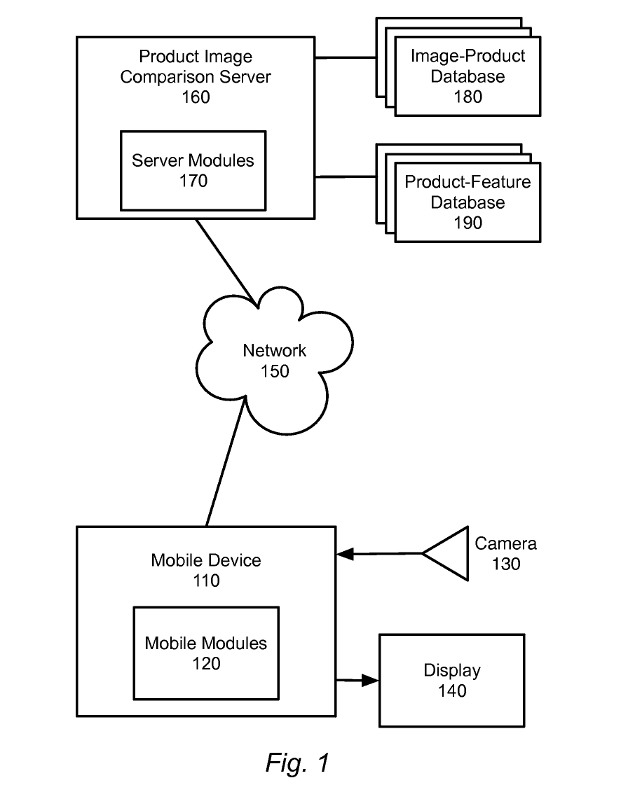

FIG. 1 is a block diagram depicting a system for comparing products within an image or video in accordance with one or more embodiments presented herein. While shopping in a marketplace, such as a store, a user can capture an image of products. The image may be captured using a camera 130 associated with a mobile device 110. The mobile device 110 may also include a visual display 140. The mobile device 110 can execute computer instructions associated with one or more mobile modules 120 to implement some or all aspects of the technology presented herein.

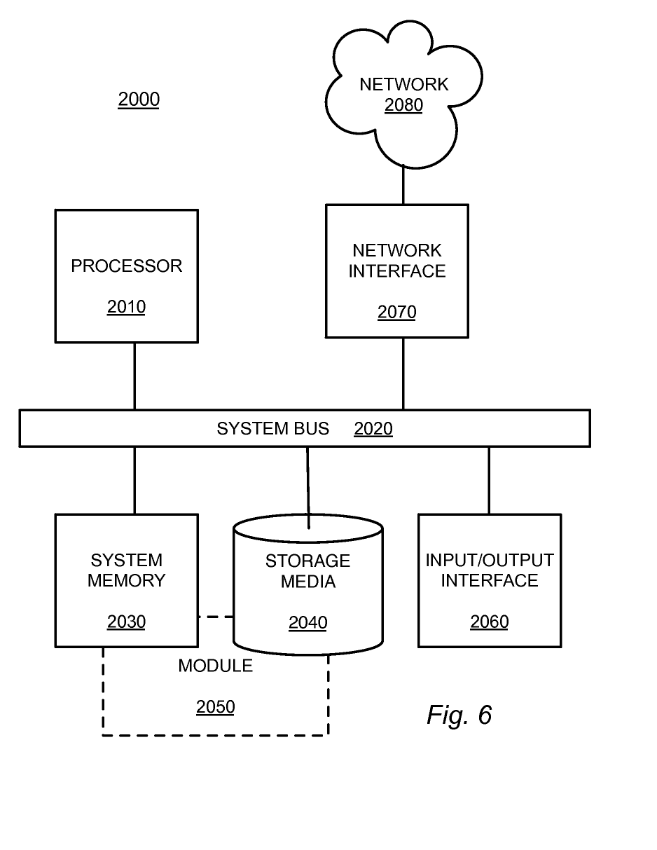

The mobile device 110 can communicate with a product image comparison server 160 over a network 150. The product image comparison server 160 can execute computer instructions associated with one or more server modules 170 to implement some or all aspects of the technology presented herein. The product image comparison server 160 can access an image-product database 180 as well as a product-feature database 190. It should be appreciated that the mobile device 110, the product image comparison server 160, and other computing machines associated with this technology may be any type of computing machine such as, but not limited to, those discussed in more detail with respect to FIG. 6. Furthermore, the mobile modules 120, the server modules 170, and any other modules (software, firmware, or hardware) associated with the technology presented herein may by any of the modules discussed in more detail with respect to FIG. 6. Also, the network 150 may be any of the network technology discussed with respect to FIG. 6.

The camera 130 associated with the mobile device 110 may be used to capture an image. The camera 130 may include one ore more optical lenses or filters. The camera 130 may include a charge-couple device (“CCD”), a photo array, a sensor array, or any other image/video capture technology. The image may depict one or more products that the user of the mobile device 110 wishes to compare features for. The term “image” as used throughout this disclosure should be understood to include a single image, multiple images, a series of images, a video, or any collection of images. A collection of images may comprise a physical array (such as a mosaic of images), a temporal array (such as a video clip, or time sequence of images), or any other set of images, whether those images are continuous, overlapping, or disjoint in time, position, or both. Images within the set may also be from varying angles, directions, zooms, close-ups, or so forth.

A visual display 140 associated with the mobile device 110 may be used as part of the user interface for the mobile device 110. The display 140 may incorporate a touch screen surface. According to one or more embodiments presented herein, the display 140 may be used to present images collected from the camera 130 to the user. Presenting images to the user can allow the user to interact with the image, such as selecting items or regions of the image to identify, search, or process as discussed herein. The display 140 may also be used to present product comparison information to the user.

The mobile device 110 may communicate over the network 150 to access the product image comparison server 160. The product image comparison server 160 can execute computer instructions associated with one or more server modules 170 to implement some or all aspects of the technology presented herein.

The image-product database 180 may include mappings of image elements to various products. The image elements may include visual identifiers as well as text or coded identifiers. These mapping from the image-product database 180 may be used to identify products from visual features, text, or coded information that is extracted from an image. Various machine vision feature detection techniques may be used to extract features from images. These machine vision techniques may include correlation, filtering, matching, edge detection, corner detection, texture matching, pattern matching, and so forth. Products may be identified from their visual shapes, patterns, outlines, textures, or other features. For example, bottles have shapes distinctive from boxes.

According to one or more embodiments, algorithms similar to, or including, the scale-invariant feature transform (“SIFT”) may be used to detect and describe image features. Such algorithms can extract structure within an image to provide feature descriptions of objects compared against training data. Training data may be provided within the image-product database 180 by applying the algorithms to images of known objects.

The image-product database 180 may include mappings of products to one or more text or coded identifiers. Visual feature functionality or algorithms may also extract text, barcodes, or other coded information from images. This information may be compared against data from the image-product database 180 to identify products or categories of products within the image. The text extracted form the image may also include product names, model numbers, manufacturer name, or any other text to use in searching the image-product database 180.

The product-feature database 190 can provide a mapping between products (or categories of products) and features or aspects of those products. For example a television product may be associated with features such as dimensional size of the screen, resolution, display technology, input ports, manufacturer, user reviews, and so forth. The features of product-feature database 190 may be used for providing product comparisons to the user of the mobile device 110. While products may have many features, the most relevant features may be presented to the user for comparison.

Features relevant to comparing products or to categories of products may be identified and specified into the product-feature database 190 manually. Relevant features may also be identified in an automated fashion or refined/maintained in an automated fashion once manually specified. Feature relevance may be crowd sourced to identify what is most important to users. For example, features of products that are often mentioned in reviews, blogs, social media, or other online forums may be assumed to be features of high relevance or importance to users.

Feature relevance may also be established through examination of differentiating features. For example, if television products selected by the user for comparison have different diagonal dimensions, then that size feature may be relevant in comparing the products. Alternatively, if the user has selected all fifty-inch television to be compared, it is a lower relevance to compare that identical size feature between those selected products.

Feature relevance may also be prioritized through feedback from the particular user. For example, if the user always seems to request price or sort by price when comparing or searching wine products, then it may be established that price is an important and relevant feature of wine products to the particular user.

The values or data for the features within the product-feature database 190 may be populated or specified manually. They may also be provided as a feed from the manufacturer or from one or more vendors. They may also be scraped from online, print, or other sources.

It should be appreciated that, according to certain embodiments, various divisions of labor may be established between the mobile device 110 (and associated mobile modules 120) and the product image comparison server 160 (and associated pervert modules 170). According to some example embodiments, various functionality of the technology presented herein may be differently allocated for performance between the mobile device 110, the product image comparison server 160, other servers, or other computing devices. According to one of various other embodiments, all of the functionality may be carried out in an off-line, mobile environment by performing all of the functionality at the mobile device 110.

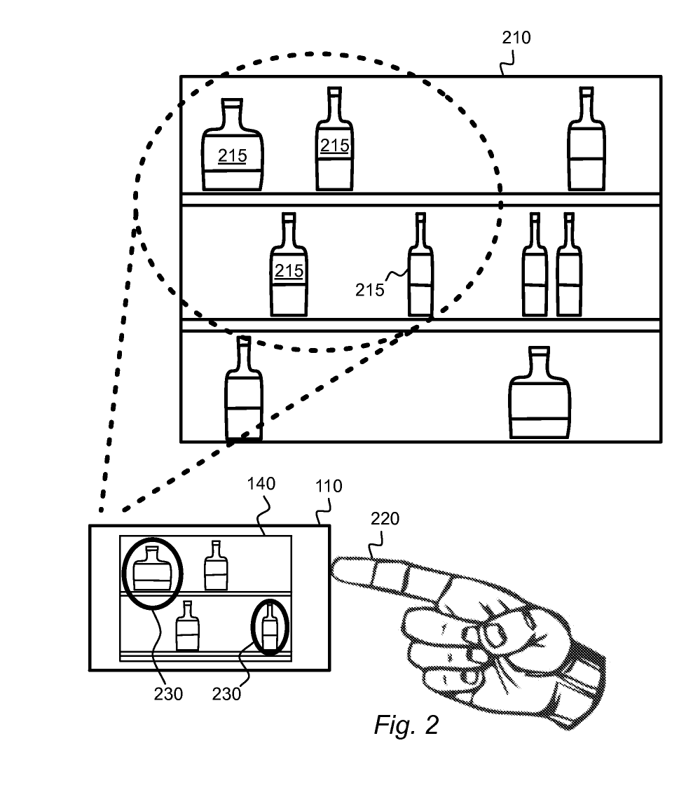

FIG. 2 is a block diagram depicting a system for capturing an image of products 215 in a marketplace 210 and selecting products 215 from within the image in accordance with one or more embodiments presented herein.

The marketplace 210 may be any type of store, warehouse, grocer, or other similar establishment. According to the illustrated example, the marketplace 210 is a shelving display of wine bottles. As such, the wine bottles are the example products 215.

The mobile device may be used for capturing an image of the marketplace 210. The image may then be presented to the user on the display 140 associated with the mobile device 110. The user may then select some or all of the products 215 for comparison. For example, the user may use their finger 220 to circle the selected products on the display 140. Lines 230 may be presented on the display to show the user where they have selected products 215. Products 215 may also be selected for comparison by the user through clicking or touching on the products in the display 140.

Other selection techniques may be used such as voice command. For example, the user may speak the command “compare the 2010 happy leaf merlot with the 2011 otter farms merlot” into a microphone associated with the mobile device 110. According to one or more embodiments, a voice command might also be used in classifying objects within the image. For example, if a voice command indicated to “compare wine X with wine Y,” then the word “wine” can be used as a feature for identifying the product and/or the product category.

Upon evaluation of the selected products, other products may be suggested to the user. These other products may be suggested because they have a higher rating, a better price, are similar to the selected products or for any other reasons.

After selection of products 215 to be compared, the selected products may be specifically identified using machine vision techniques applied to the image. For example, visual feature extraction, text extraction, or various coding extractions may be used to identify the specific bottles of wine such as the year, vineyard, and variety. These specific products may then be compared feature by feature and a comparison result may be created to present to the user. The result may include a table of compared features to be presented to user on the display 140.

The products 215 to be compared may be classified into one or more categories for feature comparison. The products 215 assigned to a particular category may share a set of features. For example, wine products may have volume, percentage of alcohol, color, sweetness, rating score, reviews, and so forth. However, some of these features may be meaningless for television products where instead other features such as diagonal dimension and resolution may be quite relevant. When a category cannot be automatically identified, one or more likely categories may be presented to the user for selection at the mobile device 110.

According to one or more embodiments, global positioning satellite (“GPS”) or other positioning technology may be used to identify the location of the mobile device 110 and thus the location or name of the marketplace 210. Such information may be used to narrow or determine the product category.

### Example Processes

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

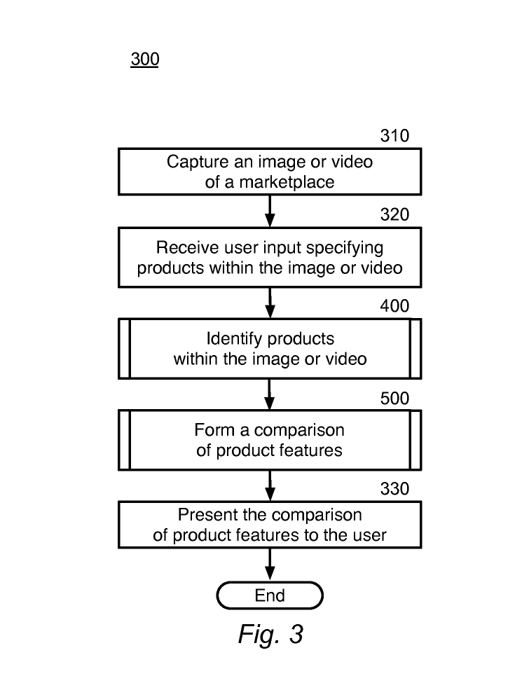

FIG. 3 is a block flow diagram depicting a method 300 for comparing products within an image or video in accordance with one or more embodiments presented herein.

In block 310, an image may be captured. The image may be captured using the camera 130 into the mobile device 110. The image may be of products 215, signs, or packages within a physical marketplace 210. The user of the mobile device 110 can initiate capture of the image.

In block 320, the user of the mobile device 110 may specify products within the image or video that was captured in block 310. The user may select the products using a touch screen associated with the mobile device 110 or using any other input device. The user may select the products individually. For example, by circling a product, touching, or clicking on a product. The user may also select products in groups. For example, by circling an area containing multiple products or by multi-touching on multiple products.

According to one or more embodiments, the image may be presented to the user as captured for selection of products 215 by the user. According to one or more other embodiments, the products 215 within the image may be automatically identified (for example according to method 400) prior to presentation to the user for selection of which specific products 215 to compare. Where the products are automatically identified first, the user selection display may include graphical or textual descriptive overlays to provide details as to the identity of each product 215 thereby aiding the selection process.

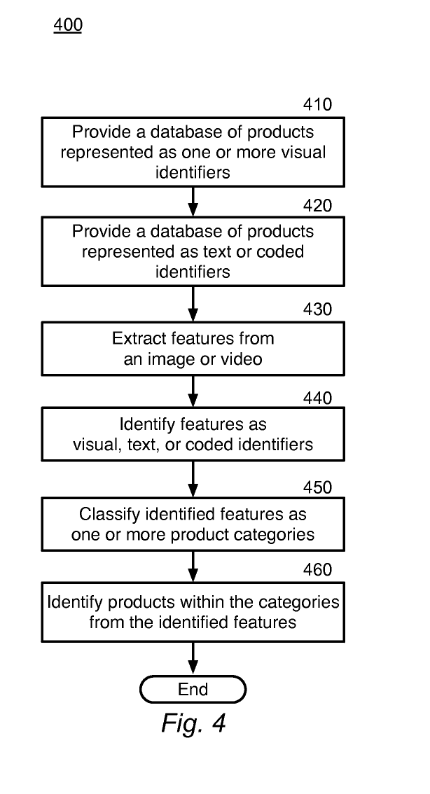

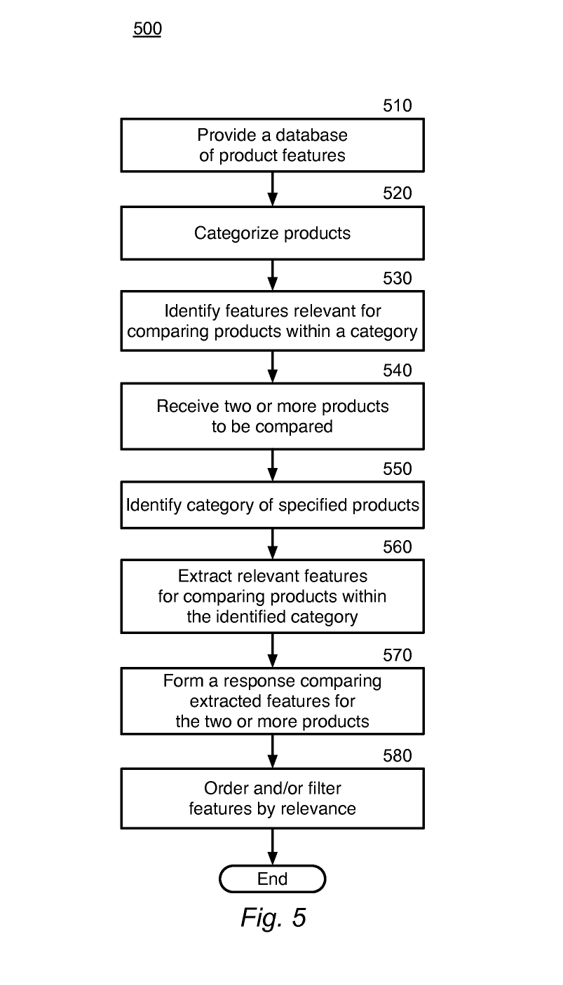

After block 320, the selected products 215 or image areas may be identified according to method 400 as discussed in further detail with respect to FIG. 4. After identifying products according to method 400, a comparison of product features may be formed according to method 500 as discussed in further detail with respect to FIG. 5.

In block 330, the comparison of product features may be presented to the user associated with the mobile device 110. The comparison of product features may have been formed according to method 500. The products being compared may be some or all of the products captured in the image in block 310 and selected by the user in block 320. The comparison information may be presented in a table or other formatted output. The comparison information may be presented to the user on the display 140 associated with the mobile device 110.

After block 330, the method 300 ends. Of course, the user can continue to capture images in the marketplace 210 and selecting products 215 from the images to be compared through repeated application of method 300.

According to some embodiments, blocks 310, 320, and 330 may be performed in association with the mobile device 110, while the methods 400 and 500 may be performed in association with the product image comparison server 160. It should be appreciated that according to some other embodiments, the various blocks of methods 300, 400, and 500 may be differently allocated for performance between the mobile device 110, the product image comparison server 160, other servers, or other computing devices. For example, according to one or more of various other embodiments, all of the collected blocks of methods 300, 400, and 500 may be carried out in an off-line, mobile environment by performing all of the blocks at the mobile device 110.

FIG. 4 is a block flow diagram depicting a method 400 for identifying products 215 within an image or video in accordance with one or more embodiments presented herein.

In block 410, information relating products with one or more visual identifiers may be provided as part of the image-product database 180. The image-product database 180 may include a mapping of visual identifiers, such as image features, to one or more products. This mapping from the image-product database 180 may be used to identify products 215 from visual or image features extracted from an image.

In block 420, information products with text or coded identifiers may be provided as part of the image-product database 180. The image-product database 180 may include a mapping of text or coded identifiers to one or more products. This mapping from the image-product database 180 may be used to identify products from text or codes extracted from an image. The text may include product names, model numbers, manufacturers, or any other text. The codes may include barcodes or other symbols.

In block 430, features within the image may be extracted. Feature extraction may be performed according to various machine vision feature detection techniques such as SIFT algorithms, correlation, filtering, matching, or the detection of edges, corners, textures, blobs, ridges, wavelets, patterns, and so forth.

In block 440, features from within the image may be identified as visual, text, or coded identifiers. Features extracted from the image in block 430 may be identified or matched as visual features with the visual identifiers of products as discussed with respect to block 410. Furthermore, features extracted from the image in block 430 may be identified or matched as text or coded identifiers of products as discussed with respect to block 420. This identification can provide a list of the specific products 215 captured within an image or video of a marketplace 210.

In block 450, identified features from the image may be used to classify objects in the image to one or more product categories. The features identified in block 440 may be classified by size, shape, pattern, or other attributes into categories for products 215. For example, if features related to the shape of wine bottles are identified, the product category of wine bottles may be used to further refine the identification of products within that category from the image. The determined product category may also inform which features of the products are relevant for comparing the products.

In block 460, products 215 within the categories may be identified from the identified features. The features identified in block 440 may be used to identify products 215 within the image according to visual, text, or coded identifiers within the image-product database 180. When possible, categories identified in block 450 may be leveraged to inform, simplify, or improve product identification.

After block 460, the method 400 ends. Of course, product identification within images and videos may continue through repeated application of method 400.

FIG. 5 is a block flow diagram depicting a method 500 for comparing product features in accordance with one or more embodiments presented herein.

In block 510, the product-feature database 190 may be accessed. The product-feature database 190 can provide a mapping between products (or categories of products) and features. The products 215, such as those selected for comparison according to method 300 and identified from an image according to method 400, may be compared according to the categories and features of the products

In block 520, products within the product-feature database 190 may be categorized. These product categories may inform which features of the products are relevant for comparing the products.

In block 530, features that are relevant for comparing selected products within a category may be identified and provided within the product-feature database 190. The relevant features for a category may have been specified manually into the product-feature database 190. Relevant features may also be determined from crowd sourcing, reviews, online forums, product specification, or so forth. The relevant features may be determined or ordered based on importance to users in general as well as preferences of the particular user of the mobile device 110.

In block 540, identities of two or more products 215 may be provided for comparison. Information about these products 215 may be retrieved from the product-feature database 190.

In block 550, the products 215 provided in block 540 may be categorized into a product category according to information provided within the product-feature database 190. For example, if the products are all laptop computers, the category of “computer” may be identified. Either a more specific category of “laptop computer,” or a broader category of “electronic device” may also be identified.

In block 560, relevant features for comparing the products 215 provided in block 540 may be extracted from the product-feature database 190. For example, if the products are televisions, features such as diagonal dimension, resolution, type of input ports, and so forth may be extracted from the product-feature database 190 for each one of the products. These features may be useful for comparing the particular products 215. The product categories determined in block 550 may inform which features are most relevant to compare for the products. Relevant features may also be determined or ordered based on differentiating features of the selected products.

In block 570, response may be formed comparing the extracted features for the two or more products. The response may be provided as a table or other format of use to the user of the mobile device 110.

In block 580, the features of the comparison response may be ordered or filtered by relevance. For example, the features most relevance to users in general, or the particular user, may be placed at the top of the table or other results format. As another example, non-differentiating features may be filtered out entirely. For example, if five bottles of wine are being compared and they are all red wine, the comparison feature of color may not be highly relevant.

After block 580, the method 500 ends and the comparison results are communicated to method 300. Of course, the comparison of product features may continue through repeated application of method 500.

### Other Example Embodiments

FIG. 6 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method for comparing products in a marketplace, comprising:
capturing, using one or more computing devices, an image or video;
identifying, using the one or more computing devices, two or more products within the image or video;
retrieving, using the one or more computing devices, at least one product feature associated with each of the two or more products;
forming, using the one or more computing devices, a comparison of the retrieved at least one product feature associated with each of the two or more products; and
presenting, using the one or more computing devices, the comparison.

2. The computer-implemented method of claim 1, wherein identifying the two or more products within the image or video comprises receiving, using the one or more computing devices, a selection input into the user computing device specifying one or more regions within the image or video with which the two or more products are associated.

3. The computer-implemented method of claim 1, wherein identifying the two or more products within the image or video comprises extracting visual features from the image or video.

4. The computer-implemented method of claim 1, wherein identifying the two or more products within the image or video comprises identifying text or barcode information within the image or video.

5. The computer-implemented method of claim 1, wherein identifying the two or more products within the image or video comprises classifying visual features within the image or video into a category and identifying products of the classified category.

6. The computer-implemented method of claim 1, wherein retrieving product features associated with each of the two or more products comprises identifying a category associated with the two or more products and retrieving product features relevant to the category.

7. The computer-implemented method of claim 1, wherein forming a comparison of product features comprises formatting product features into a comparison table.

8. The computer-implemented method of claim 1, wherein forming a comparison of product features comprises identifying and ranking product features most relevant to users.

9. The computer-implemented method of claim 1, wherein forming a comparison of product features comprises removing non-differentiating features.

10. A mobile system for comparing products in a market place, the system comprising:
one or more computing processors;
an electronic camera;
an electronic display; and
one or more modules operable in combination with the one or more processors to:
capture an image using the camera;
apply machine vision techniques to identify a plurality of products within the image;
retrieve features of the identified products; and
present a comparison of the features on the display.

11. The mobile system of claim 10, wherein the one or more modules are further operable, in combination with the one or more processors, to receive input from a user indicating a selection of products within the image to be compared.

12. The mobile system of claim 10, wherein applying machine vision techniques and retrieving features of the identified products are performed using one or more computing devices in data communication with the mobile system.

13. The mobile system of claim 10, wherein the machine vision techniques comprise scale-invariant feature transformations.

14. The mobile system of claim 10, wherein the camera is a video camera, and wherein the captured image is a video.

15. A computer program product, comprising:
a non-transitory computer-readable medium having computer-readable program code embodied therein for comparing products in a market place that when executed by one or more computing devices cause the one or more computing devices to perform operations comprising:
receiving an electronic image taken by a camera;
receiving input from a user selecting two or more products within the image;
applying machine vision techniques to specifically identify the selected two or more products;
retrieving product features associated with each of the identified products;
forming a comparison of the retrieved product features; and
presenting the comparison to the user.

16. The computer program product of claim 15, wherein applying machine vision techniques comprises extracting visual features from the image;

17. The computer program product of claim 15, wherein applying machine vision techniques comprises extracting text or coded information from the image.

18. The computer program product of claim 15, wherein retrieving product features comprises identifying a category associated with the identified products.

19. The computer program product of claim 15, wherein forming a comparison of the retrieved product features comprises formatting the retrieved product features into a comparison table.

20. The computer program product of claim 15, wherein forming a comparison of the retrieved product features comprises identifying product features most relevant to users.

21. The computer program product of claim 15, wherein forming a comparison of the retrieved product features comprises removing non-differentiating features.

22. The computer program product of claim 15, wherein the image is a video.
